(19) United States
(12) Patent Application Publication
(10) Pub. No.: US 2026/0104804 A1
(43) Pub. Date: Apr. 16, 2026

(54) MEMORY CONTROL METHOD AND MEMORY STORAGE DEVICE

(71) Applicant: Hefei Kaimeng Technology Co., Ltd., Anhui (CN)

(72) Inventors: Yan ZHENG, Anhui (CN); Dongsheng Guan, Anhui (CN); Zhi Wang, Anhui (CN); Qiao Zhu, Anhui (CN); Tsung-Lin Wu, Anhui (CN)

(73) Assignee: Hefei Kaimeng Technology Co., Ltd., Anhui (CN)

(21) Appl. No.: 19/260,592

(22) Filed: Jul. 6, 2025

(30) Foreign Application Priority Data
Oct. 15, 2024 (CN) 202411440164.6

(51) Int. Cl. G06F 3/06

(52) U.S. Cl. CPC G06F 3/0619; G06F 3/0653; G06F 3/0679

(57) ABSTRACT

A memory control method and a memory storage device may extend service life and ensure reliability of data. The memory control method is used for a rewritable non-volatile memory module including multiple physical units, and includes: when an error occurs in a target operation executed on a first physical unit, obtaining an execution count of the first physical unit; if the execution count and operation type indicate that the first physical unit satisfies the first preset condition, determining whether the first physical unit is the third type; if the first physical unit is not the third type and the execution count indicates that the first physical unit satisfies the second preset condition, determining whether the first physical unit is the second type; and if the first physical unit is not the second type, marking the first physical unit as the second type.

### CROSS-REFERENCE TO RELATED APPLICATION

This application claims the priority benefit of China application serial no. 202411440164.6, filed on Oct. 15, 2024. The entirety of the above-mentioned patent application is hereby incorporated by reference herein and made a part of this specification.

### BACKGROUND

### Technical Field

The disclosure relates to a field of storage technology, and in particular to a memory control method and a memory storage device.

### Related Art

With the rapid advancement of electronic products in recent years, consumers' requirements for electronic storage products increase, and the market demand for higher speed and more convenient storage solutions also continuously grows. A NAND flash memory, with advantages of data non-volatility, low power consumption, compact design, no moving parts, and fast read/write speed, has excelled in mobile application fields such as mobile phones and smart sensor devices.

With the rapid evolution of the flash memory, the NAND flash memory has undergone a transformation from two-dimensional (2D) to three-dimensional (3D), and a storage unit has also gradually evolved from a single level cell (SLC) storage unit to a triple level cell (TLC) and even a quad level cell (QLC) storage unit. The serial innovations in the technology have greatly enhanced the storage density of the NAND flash memory while reducing the cost per unit capacity. However, due to continued decrease in a thickness of an oxide layer inside the flash memory, erase/write operations cause significant impact on the storage medium, thereby affecting the durability and reliability of the flash memory.

In view of this, how to effectively manage the NAND flash memory has become one of the core topics for engineers in the industry.

### SUMMARY

The exemplary embodiments of the disclosure provide a memory control method and a memory storage device, which may extend a service life of the memory storage device on the basis of ensuring reliability of data, and may further improve the overall performance and stability of a system to ensure that users obtain a more smooth and reliable user experience.

The exemplary embodiments of the disclosure provide a memory control method used for a rewritable non-volatile memory module. The rewritable non-volatile memory module includes multiple physical units. The physical units are respectively marked as a first type, a second type, a third type, or a fourth type. The memory control method includes following steps. When an error occurs in a target operation executed on a first physical unit, an execution count of the first physical unit is obtained. If the execution count and an operation type of the target operation indicate that the first physical unit satisfies a first preset condition, whether the first physical unit is the third type is determined. If the first physical unit is not the third type and the execution count indicates that the first physical unit satisfies the second preset condition, whether the first physical unit is the second type is determined. If the first physical unit is not the second type, the first physical unit is marked as the second type.

In the exemplary embodiments of the disclosure, the first preset condition includes that the target operation is not a read operation, or the target operation is the read operation and the execution count is not greater than a read threshold, where the execution count is a read count.

In the exemplary embodiments of the disclosure, the second preset condition includes that the execution count is not greater than an erase threshold, where the execution count is an erase count.

In the exemplary embodiments of the disclosure, before the step of obtaining the execution count of the first physical unit, the method further includes following steps. Whether an operation temperature or an operation voltage corresponding to the target operation is abnormal is determined. If at least one of the operation temperature and the operation voltage is abnormal, the first physical unit is temporarily not marked.

In the exemplary embodiments of the disclosure, the memory control method further includes as follows. If the execution count and the operation type of the target operation indicate that the first physical unit does not satisfy the first preset condition, the first physical unit is temporarily not marked.

In the exemplary embodiments of the disclosure, the memory control method further includes as follows. If the first physical unit is the third type, the first physical unit is marked as the fourth type.

In the exemplary embodiments of the disclosure, the memory control method further includes as follows. If the first physical unit is not the third type and the execution count indicates that the first physical unit does not satisfy the second preset condition, the first physical unit is marked as the third type.

In the exemplary embodiments of the disclosure, the step of marking the first physical unit as the third type includes following steps. Whether the target operation is a read operation is determined. If the target operation is a read operation, the first physical unit is marked as the third type.

In the exemplary embodiments of the disclosure, the memory control method further includes as follows. If the target operation is not a read operation, the first physical unit is marked as the fourth type.

In the exemplary embodiments of the disclosure, the memory control method further includes as follows. If the first physical unit is the second type, the first physical unit is marked as the third type.

In the exemplary embodiments of the disclosure, the memory control method further includes following steps. In an idle state, based on the access mode of the first physical unit marked as the second type, a target test operation is executed on the first physical unit marked as the second type. If the target test operation successes, the first physical unit marked as the second type is re-marked as the first type.

In the exemplary embodiments of the disclosure, the memory control method further includes as follows. If the target test operation fails and the access mode is a single level cell storage unit access mode, the first physical unit marked as the second type is marked as the fourth type.

In the exemplary embodiments of the disclosure, the memory control method further includes as follows. If the target test operation fails and the access mode is not the single level cell storage unit access mode, the first physical unit marked as the second type is marked as the third type.

In the exemplary embodiments of the disclosure, the operation type is configured to characterize that the target operation is an erase operation, a write operation, or a read operation.

In the exemplary embodiments of the disclosure, the physical units are all the first type at an initial stage.

In the exemplary embodiments of the disclosure, the first physical unit marked as the third type is only used for a single level cell storage unit access mode.

The exemplary embodiments of the disclosure further provide a memory storage device including a connection interface unit, a rewritable non-volatile memory module, and a memory control circuit unit. The memory control circuit unit is coupled to the connection interface unit and the rewritable non-volatile memory module. The connection interface unit is coupled to a host system. The rewritable non-volatile memory module includes multiple physical units. The multiple physical units are respectively marked as a first type, a second type, a third type, or a fourth type. When an error occurs in a target operation executed on a first physical unit, the memory control circuit unit is configured to obtain an execution count of the first physical unit. If the execution count and an operation type of the target operation indicate that the first physical unit satisfies a first preset condition, the memory control circuit unit is further configured to determine whether the first physical unit is of the third type. If the first physical unit is not the third type and the execution count indicates that the first physical unit satisfies the second preset condition, the memory control circuit unit is further configured to determine whether the first physical unit is the second type. If the first physical unit is not the second type, the memory control circuit unit is further configured to mark the first physical unit as the second type.

In the exemplary embodiments of the disclosure, before the step of the memory control circuit unit obtaining the execution count of the first physical unit, the memory control circuit unit is further configured to determine whether an operation temperature or an operation voltage corresponding to the target operation is abnormal. If at least one of the operation temperature and the operation voltage is abnormal, the memory control circuit unit is further configured to temporarily not mark the first physical unit.

In the exemplary embodiments of the disclosure, if the execution count and the operation type of the target operation indicate that the first physical unit does not satisfy the first preset condition, the memory control circuit unit is further configured to temporarily not mark the first physical unit.

In the exemplary embodiments of the disclosure, if the first physical unit is the third type, the memory control circuit unit is further configured to mark the first physical unit as the fourth type.

In the exemplary embodiments of the disclosure, if the first physical unit is not the third type and the execution count indicates that the first physical unit does not satisfy the second preset condition, the memory control circuit unit is further configured to mark the first physical unit as the third type.

In the exemplary embodiments of the disclosure, the memory control circuit unit is further configured to determine whether the target operation is a read operation. If the target operation is the read operation, the memory control circuit unit is further configured to mark the first physical unit as the third type.

In the exemplary embodiments of the disclosure, if the target operation is not the read operation, the memory control circuit unit is further configured to mark the first physical unit as the fourth type.

In the exemplary embodiments of the disclosure, if the first physical unit is the second type, the memory control circuit unit is further configured to mark the first physical unit as the third type.

In the exemplary embodiments of the disclosure, in the idle state, the memory control circuit unit is further configured to execute a target test operation on the first physical unit marked as the second type based on an access mode of the first physical unit marked as the second type. If the target test operation successes, the memory control circuit unit is further configured to re-mark the first physical unit marked as the second type as the first type.

In the exemplary embodiments of the disclosure, if the target test operation fails and the access mode is a single level cell storage unit access mode, the memory control circuit unit is further configured to mark the first physical unit marked as the second type as the fourth type. In the exemplary embodiments of the disclosure, if the target test operation fails and the access mode is not the single level cell storage unit access mode, the memory control circuit unit is further configured to mark the first physical unit marked as the second type as the third type.

Based on the above, the disclosure provides a memory control method and a memory storage device which may temporarily not mark the physical unit corresponding to the target operation in which an error occurs as a bad physical unit when environmental factors are abnormal, so as to avoid a problem of mismarking, and execute a classification management mechanism according to actual usage conditions of the physical unit corresponding to the target operation in which an error occurs, which may extend the service life of the memory storage device under the premise of ensuring reliability of data.

To make the aforementioned features and advantages of the disclosure comprehensible, embodiments are specifically provided below and described in detail with accompanying drawings as follows.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a flowchart of a memory control method according to an exemplary embodiment of the disclosure.

FIG. 8 is a flowchart of a memory control method according to an exemplary embodiment of the disclosure.

FIG. 9 is a flowchart of a memory control method according to an exemplary embodiment of the disclosure.

FIG. 10 is a flowchart of a memory control method for a physical unit to be inspected according to an exemplary embodiment of the disclosure.

### DESCRIPTION OF THE EMBODIMENTS

Reference now is made in detail to exemplary embodiments of the disclosure, examples of which are illustrated in the accompanying drawings. Wherever possible, the same reference numerals are used in the drawings and the description to refer to the same or like parts.

Generally, a memory storage device (also referred to as a memory storage system) includes a rewritable non-volatile memory module and a controller (also referred to as a control circuit). The memory storage device may be used with a host system, so that the host system may write data to the memory storage device or read data from the memory storage device.

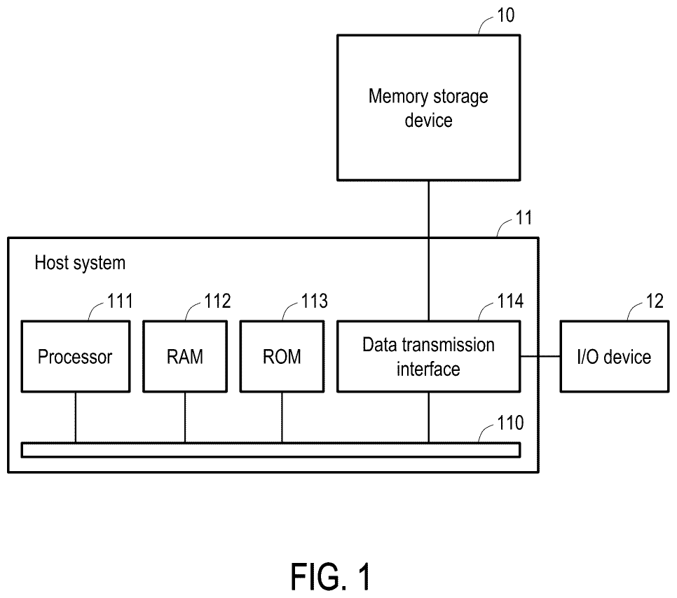

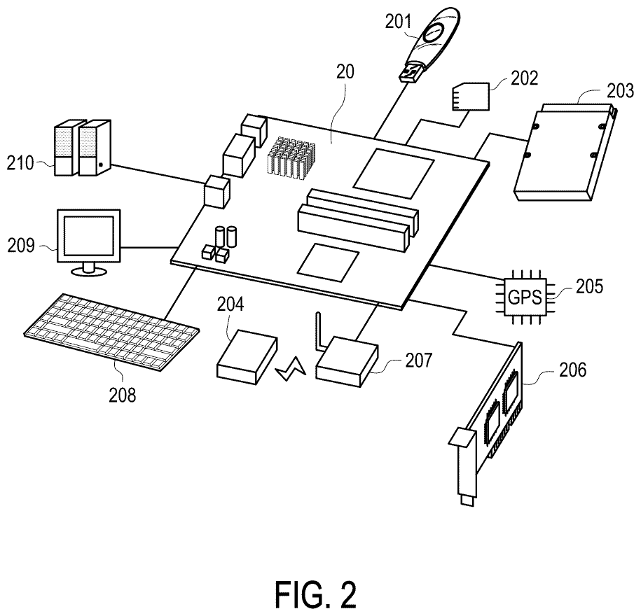

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIG. 1 and FIG. 2, a host system 11 may include a processor 111, a random access memory (RAM) 112, a read only memory (ROM) 113, and a data transmission interface 114. The processor 111, the RAM 112, the ROM 113, and the data transmission interface 114 may be coupled to a system bus 110.

In an exemplary embodiment, the host system 11 may be coupled to the memory storage device 10 through the data transmission interface 114. For example, the host system 11 may store data to the memory storage device 10 or read data from the memory storage device 10 through the data transmission interface 114. Additionally, the host system 11 may be coupled to the I/O device 12 through the system bus 110. For example, the host system 11 may transmit output signals to the I/O device 12 or receive input signals from the I/O device 12 through the system bus 110.

In an exemplary embodiment, the processor 111, the RAM 112, the ROM 113, and the data transmission interface 114 may be disposed on a motherboard 20 of the host system 11. A number of the data transmission interface 114 may be one or multiple. Through the data transmission interface 114, the motherboard 20 may be coupled to the memory storage device 10 in a wired or wireless manner.

In an exemplary embodiment, the memory storage device 10 may be, for example, a USB flash drive 201, a memory card 202, a solid state drive (SSD) 203, or a wireless memory storage device 204. The wireless memory storage device 204 may be, for example, a Near Field Communication (NFC) memory storage device, a WiFi memory storage device, a Bluetooth memory storage device, or a low power Bluetooth memory storage device (for example, iBeacon), which are memory storage devices based on various wireless communication technologies. Additionally, the motherboard 20 may also be coupled to various I/O devices such as a global positioning system (GPS) module 205, a network interface card 206, a wireless transmission device 207, a keyboard 208, a screen 209, and a speaker 210 through the system bus 110. For example, in an exemplary embodiment, the motherboard 20 may access the wireless memory storage device 204 through the wireless transmission device 207.

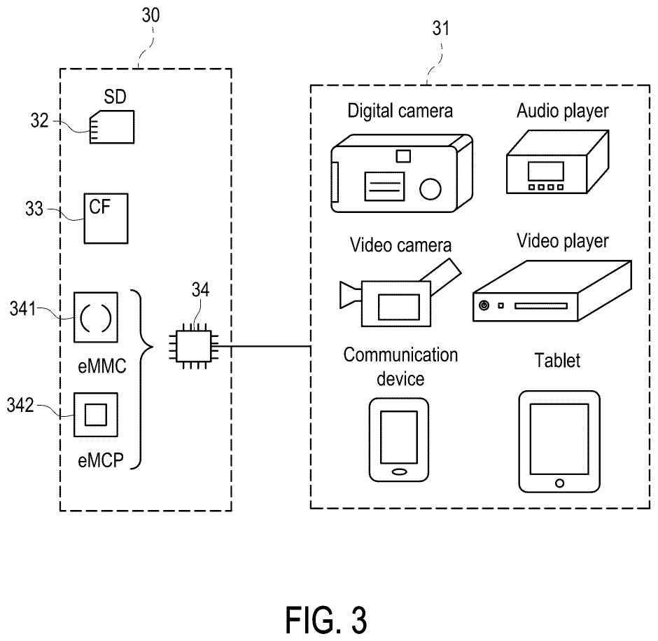

In an exemplary embodiment, the host system 11 is a computer system. In an exemplary embodiment, the host system 11 may be any system that may substantially cooperate with the memory storage device to store data. In an exemplary embodiment, the host system 11 is a vehicle system. In an exemplary embodiment, the memory storage device 10 and the host system 11 may respectively include a memory storage device 30 and a host system 31 in FIG. 3.

FIG. 3 is a schematic diagram of a host system and a memory storage device according to an exemplary embodiment of the disclosure.

Referring to FIG. 3, the memory storage device 30 may be used with the host system 31 to store data. For example, the host system 31 may be a system such as a digital camera, a video camera, a communication device, an audio player, a video player, or a tablet. For example, the memory storage device 30 may be various types of non-volatile memory storage devices such as a secure digital (SD) card 32, a compact flash (CF) card 33, or an embedded storage device 34 used by the host system 31. The embedded storage device 34 includes various types of embedded storage devices such as an embedded multi media card (eMMC) 341, and/or an embedded multi chip package (eMCP) storage device 342 that directly couple memory modules to a substrate of the host system.

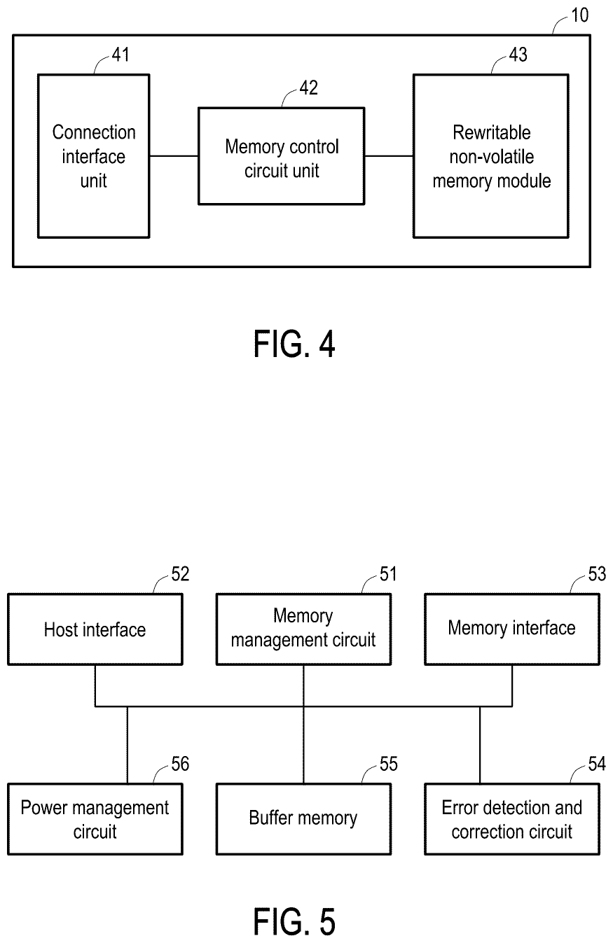

FIG. 4 is a schematic diagram of a memory storage device according to an exemplary embodiment of the disclosure.

Referring to FIG. 4, the memory storage device 10 includes a connection interface unit 41, a memory control circuit unit 42, and a rewritable non-volatile memory module 43.

The connection interface unit 41 is configured to couple the memory storage device 10 to the host system 11. The memory storage device 10 may communicate with the host system 11 through the connection interface unit 41. In an exemplary embodiment, the connection interface unit 41 is compatible with the Peripheral Component Interconnect Express (PCI Express) standard. In an exemplary embodiment, the connection interface unit 41 may also be compliant with the Serial Advanced Technology Attachment (SATA) standard, the Parallel Advanced Technology Attachment (PATA) standard, the Institute of Electrical and Electronic Engineers (IEEE) 1394 standard, the Universal Serial Bus (USB) standard, the SD interface standard, the Ultra High Speed-I (UHS-I) interface standard, the Ultra High Speed-II (UHS-II) interface standard, the Memory Stick (MS) interface standard, the MCP interface standard, the MMC interface standard, the eMMC interface standard, the Universal Flash Storage (UFS) interface standard, the eMCP interface standard, the CF interface standard, the Integrated Device Electronics (IDE) standard, or other suitable standards. The connection interface unit 41 may be packaged with the memory control circuit unit 42 in one chip, or the connection interface unit 41 is disposed outside a chip that includes the memory control circuit unit 42.

The memory control circuit unit 42 is coupled to the connection interface unit 41 and the rewritable non-volatile memory module 43. The memory control circuit unit 42 is configured to execute multiple logic gates or control instructions implemented in a hardware form or a firmware form and to perform operations such as writing, reading, and erasing of data in the rewritable non-volatile memory module 43 according to instructions from the host system 11.

The rewritable non-volatile memory module 43 is configured to store data written by the host system 11. The rewritable non-volatile memory module 43 may include a single level cell (SLC) NAND flash memory module (that is, a flash memory module capable of storing 1 bit in one storage unit), a multi level cell (MLC) NAND flash memory module (that is, a flash memory module capable of storing 2 bits in one storage unit), a triple level cell (TLC) NAND flash memory module (that is, a flash memory module capable of storing 3 bits in one storage unit), a quad level cell (QLC) NAND flash memory module (that is, a flash memory module capable of storing 4 bits in one storage unit), other flash memory modules, or other memory modules having the same characteristics.

Each storage unit of the rewritable non-volatile memory module 43 stores one or multiple bits through changes in voltage (hereinafter also referred to as a threshold voltage). Specifically, there is a charge trapping layer between a control gate and a channel of each storage unit. By applying a write voltage to the control gate, the amount of electrons of the charge trapping layer may be changed, thereby changing the threshold voltage of the storage unit. The operation of changing the threshold voltage of the storage unit is also referred to as “writing data to the storage unit” or “programming the storage unit”. With the change of the threshold voltage, each storage unit of the rewritable non-volatile memory module 43 has multiple storage states. By applying a read voltage, which storage state a storage unit belongs to may be determined, thereby obtaining the one or multiple bits stored in this storage unit.

In an exemplary embodiment, the storage units of the rewritable non-volatile memory module 43 may constitute multiple physical programming units, and the physical programming units may constitute multiple physical units. Specifically, storage units on the same word line may form one or multiple physical programming units. If each storage unit may store more than 2 bits, the physical programming units on the same word line may at least be classified as lower physical programming units and upper physical programming units. For example, the least significant bit (LSB) of a storage unit belongs to the lower physical programming unit, and the most significant bit (MSB) of a storage unit belongs to the upper physical programming unit.

Generally, in the MLC NAND flash memory, a write speed of the lower physical programming unit may be greater than a write speed of the upper physical programming unit, and/or the reliability of the lower physical programming unit is higher than the reliability of the upper physical programming unit.

In an exemplary embodiment, the physical programming unit is the smallest unit for programming. That is, the physical programming unit is the smallest unit for writing data. For example, the physical programming unit may be a physical page or a physical sector. If the physical programming unit is a physical page, the physical programming units may include a data bit area and a redundancy bit area. The data bit area includes multiple physical sectors for storing user data, while the redundancy bit area is configured to store system data (for example, management data such as error correction codes). In this exemplary embodiment, the data bit area includes 32 physical sectors, and the size of each physical sector is 512 bytes (B). However, in other exemplary embodiments, the data bit area may also include 8, 16, or more or fewer physical sectors, and the size of each physical sector may also be larger or smaller. In another aspect, the physical unit is the smallest unit for erasing. That is, each physical unit includes the minimum number of storage units that are erased together. For example, the physical unit is a physical block.

FIG. 5 is a schematic diagram of a memory control circuit unit according to an exemplary embodiment of the disclosure.

Referring to FIG. 5, the memory control circuit unit 42 includes a memory management circuit 51, a host interface 52, and a memory interface 53.

The memory management circuit 51 is configured to control the overall operation of the memory control circuit unit 42. Specifically, the memory management circuit 51 has multiple control instructions. When the memory storage device 10 operates, the control instructions may be executed to perform operations such as writing, reading, and erasing of data. The following description of the operation of the memory management circuit 51 is equivalent to the description of the operation of the memory control circuit unit 42.

In an exemplary embodiment, the control instructions of the memory management circuit 51 are implemented in a firmware form. For example, the memory management circuit 51 has a microprocessor unit (not shown) and a read only memory (not shown), and the control instructions are burned into the ROM. When the memory storage device 10 operates, the control instructions may be executed by the microprocessor unit to perform operations such as writing, reading, and erasing of data.

In an exemplary embodiment, the control instructions of the memory management circuit 51 may also be stored in a code form in a specific area of the rewritable non-volatile memory module 43 (for example, a system area of the memory module dedicated to storing system data). In addition, the memory management circuit 51 has a microprocessor unit (not shown), a read only memory (not shown), and a random access memory (not shown). In particular, the ROM has a boot code. When the memory control circuit unit 42 is enabled, the microprocessor unit may first execute the boot code to load the control instructions stored in the rewritable non-volatile memory module 43 into the RAM of the memory management circuit 51. Thereafter, the microprocessor unit may operate the control instructions to perform operations such as writing, reading, and erasing of data.

In an exemplary embodiment, the control instructions of the memory management circuit 51 may also be implemented in a hardware form. For example, the memory management circuit 51 includes a microcontroller, a storage unit management circuit, a memory write circuit, a memory read circuit, a memory erase circuit, and a data processing circuit. The storage unit management circuit, the memory write circuit, the memory read circuit, the memory erase circuit, and the data processing circuit are coupled to the microcontroller. The storage unit management circuit is configured to manage storage units or storage unit groups of the rewritable non-volatile memory module 43. The memory write circuit is configured to issue write instruction sequences to the rewritable non-volatile memory module 43 to write data into the rewritable non-volatile memory module 43. The memory read circuit is configured to issue read instruction sequences to the rewritable non-volatile memory module 43 to read data from the rewritable non-volatile memory module 43. The memory erase circuit is configured to issue erase instruction sequences to the rewritable non-volatile memory module 43 to erase data from the rewritable non-volatile memory module 43. The data processing circuit is configured to process data to be written into the rewritable non-volatile memory module 43 and data read from the rewritable non-volatile memory module 43. The write instruction sequences, the read instruction sequences, and the erase instruction sequences may each include one or multiple codes or instruction codes and are configured to instruct the rewritable non-volatile memory module 43 to execute corresponding write, read, and erase operations. In an exemplary embodiment, the memory management circuit 51 may also issue other types of instruction sequences to the rewritable non-volatile memory module 43 to instruct execution of corresponding operations.

The host interface 52 is coupled to the memory management circuit 51. The memory management circuit 51 may communicate with the host system 11 through the host interface 52. The host interface 52 may be configured to receive and identify instructions and data transmitted by the host system 11. For example, the instructions and data transmitted by the host system 11 may be transmitted to the memory management circuit 51 through the host interface 52. In addition, the memory management circuit 51 may transmit data to the host system 11 through the host interface 52. In the present exemplary embodiment, the host interface 52 is compatible with the PCI Express standard. However, it must be understood that the disclosure is not limited thereto, and the host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and configured to access the rewritable non-volatile memory module 43. For example, the memory management circuit 51 may access the rewritable non-volatile memory module 43 through the memory interface 53. That is, data to be written to the rewritable non-volatile memory module 43 is converted through the memory interface 53 into a format acceptable to the rewritable non-volatile memory module 43. Specifically, if the memory management circuit 51 needs to access the rewritable non-volatile memory module 43, the memory interface 53 may transmit corresponding instruction sequences. For example, the instruction sequences may include write instruction sequences indicating writing data, read instruction sequences indicating reading data, erase instruction sequences indicating erasing data, and corresponding instruction sequences configured to indicate various memory operations (for example, changing read voltage levels or executing garbage collection operations). The instruction sequences are, for example, generated by the memory management circuit 51 and transmitted to the rewritable non-volatile memory module 43 through the memory interface 53. The instruction sequences may include one or multiple signals, or data on a bus. The signals or data may include instruction codes or codes. For example, in the read instruction sequence, information such as read identification codes and memory addresses may be included.

In an exemplary embodiment, the memory control circuit unit 42 further includes an error detection and correction circuit 54, a buffer memory 55, and a power management circuit 56.

The error detection and correction circuit 54 is coupled to the memory management circuit 51 and configured to execute error detection and correction operations to ensure correctness of data. Specifically, when the memory management circuit 51 receives a write instruction from the host system 11, the error detection and correction circuit 54 may generate a corresponding error correcting code (ECC) and/or error detecting code (EDC) for the data corresponding to the write instruction, and the memory management circuit 51 may write the data corresponding to the write instruction and the corresponding ECC and/or EDC to the rewritable non-volatile memory module 43. Thereafter, when reading data from the rewritable non-volatile memory module 43, the memory management circuit 51 may simultaneously read the ECC and/or EDC corresponding to the data, and the error detection and correction circuit 54 may execute error detection and correction operations on the read data according to the ECC and/or EDC.

The buffer memory 55 is coupled to the memory management circuit 51 and configured to temporarily store data. The power management circuit 56 is coupled to the memory management circuit 51 and configured to control the power of the memory storage device 10.

In an exemplary embodiment, the rewritable non-volatile memory module 43 in FIG. 4 may include a flash memory module. In an exemplary embodiment, the memory control circuit unit 42 in FIG. 4 may include a flash memory controller. In an exemplary embodiment, the memory management circuit 51 in FIG. 5 may include a flash memory management circuit.

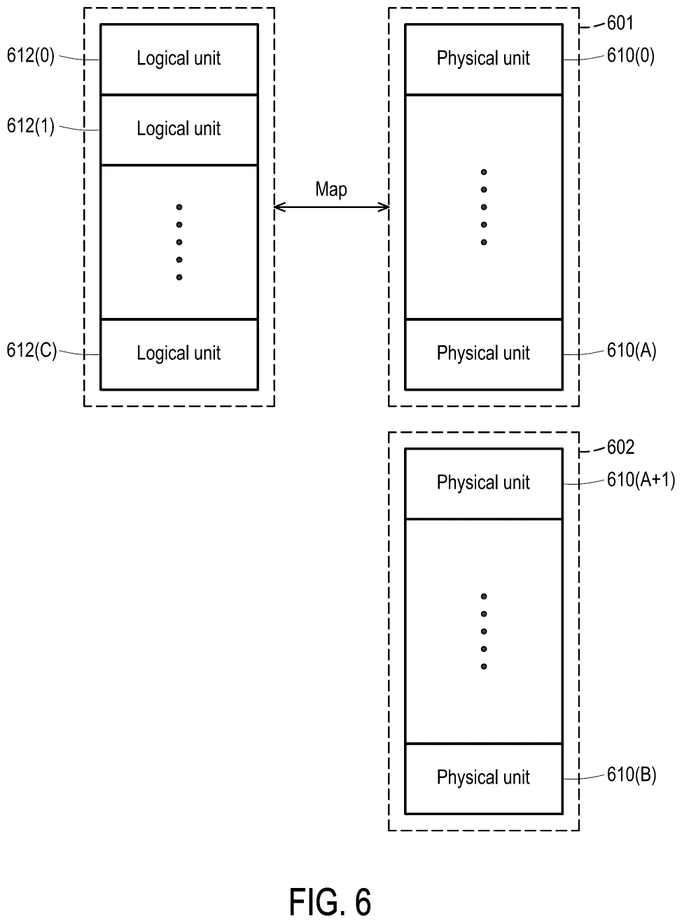

FIG. 6 is a schematic diagram of managing a rewritable non-volatile memory module according to an exemplary embodiment of the disclosure.

Referring to FIG. 6, the memory management circuit 51 may logically group physical units 610(0) to 610(B) of the rewritable non-volatile memory module 43 into a storage area 601 and a spare area 602. A physical unit refers to a virtual block (VB). A virtual block may include multiple physical programming units. For example, a virtual block may include one or multiple physical units.

The physical units 610(0) to 610(A) in the storage area 601 are configured to store user data (for example, user data from the host system 11 in FIG. 1). For example, the physical units 610(0) to 610(A) in the storage area 601 may store valid data and invalid data. The physical units 610(A+1) to 610(B) in the spare area 602 do not store data (for example, valid data). For example, if a certain physical unit does not store valid data, the physical unit may be associated with (or added to) the spare area 602. Furthermore, the physical units (or physical units that do not store valid data) in the spare area 602 may be erased. When new data is written, one or multiple physical units may be extracted from the spare area 602 to store the new data. In an exemplary embodiment, the spare area 602 is also referred to as a free pool.

The memory management circuit 51 may dispose logical units 612(0) to 612(C) to map the physical units 610(0) to 610(A) in the storage area 601. In an exemplary embodiment, each logical unit corresponds to a logical address. For example, a logical address may include one or multiple logical block addresses (LBA) or other logical management units.

It should be noted that a logical unit may be mapped to one or multiple physical units. If a certain physical unit is currently mapped by a certain logical unit, it is shown that the data currently stored in this physical unit includes valid data. Conversely, if a certain physical unit is currently not mapped by any logical unit, it is shown that the data currently stored in this physical unit does not include any valid data.

The memory management circuit 51 may record management data (also referred to as logical-to-physical mapping information) describing a mapping relationship between logical units and physical units in at least one logical-to-physical mapping table. When the host system 11 intends to read data from the memory storage device 10 or write data to the memory storage device 10, the memory management circuit 51 may execute data access operations on the memory storage device 10 according to the information in the logical-to-physical mapping table.

When an error occurs in the data access operation, a conventional error handle method is to mark the physical unit corresponding to the data access operation as a bad physical unit and replace the physical unit to maintain the operation of the memory storage device 10. However, in a process of the memory management circuit 51 executing the data access operation on the memory storage device 10, the memory storage device 10 may be affected by environmental factors (for example, abnormal operating voltage or abnormal temperature), which may cause errors in the data access operation. Under this condition, the physical unit corresponding to the data access operation may not be a damaged bad physical unit. The conventional error handle method may erroneously mark an undamaged physical unit as a bad physical unit, thereby reducing a service life of the memory storage device 10.

To avoid the aforementioned problems, the disclosure provides a memory control method. When the memory storage device 10 is affected by the environmental factors, the memory management circuit 51 may temporarily not mark the physical unit corresponding to the operation in which an error occurs as a bad physical unit, to avoid a problem of mismarking, and establish a physical unit management mechanism for the physical unit according to the actual operating conditions of the rewritable non-volatile memory module 43. By performing classification marking on the physical units with different usage conditions, under the premise of ensuring reliability of data, the misjudgment of physical unit classification is reduced, and the service life of the memory storage device 10 is extended.

In an exemplary embodiment, the rewritable non-volatile memory module 43 may, for example, include multiple physical units, and the physical units of the rewritable non-volatile memory module 43 are all a first type at the initial stage. That is, at the initial stage of the service life of the memory storage device 10, the physical units of the rewritable non-volatile memory module 43 are all the first type. As usage time progresses, the physical units of the rewritable non-volatile memory module 43 may be divided (or marked) into the first type, the second type, the third type, or the fourth type according to actual usage conditions.

Regarding definitions of the first type, the second type, the third type, and the fourth type, reference may be made to Table 1 below.

TABLE 1

| Type | Definition |
|---|---|
| First type | Good condition, available for various access modes, |
| | and no errors have occurred |
| Second type | Good condition, available for various access modes, |
| | but errors have occurred, and in idle state, needs |
| | to be inspected again |
| Third type | Poor condition, only usable for single level cell |
| | storage unit access mode |
| Fourth type | Damaged and no longer used |

As shown in Table 1, first type and second type physical units may be used for various access modes. The access modes may include but may not be limited to a single level cell (SLC) storage unit access mode, a multi-level cell (MLC) storage unit access mode, a triple-level cell (TLC) storage unit access mode, or a quad-level cell (QLC) storage unit access mode. The access modes supported by the memory storage device 10 may depend on the specifications thereof. In an exemplary embodiment, the first type physical unit is also referred to as a good physical unit.

Furthermore, the second type physical unit needs to be inspected again in an idle state. That is, in the idle state, the memory management circuit 51 may execute a target test operation on the second type physical unit to determine whether the physical unit may be used for the subsequent data access operation. In an exemplary embodiment, the second type physical unit are also referred to as a physical unit to-be inspected.

Furthermore, a third type physical unit may only be used for the SLC storage unit access mode. In an exemplary embodiment, the third type physical unit are also referred to as a weak physical unit.

Furthermore, a fourth type physical unit is damaged and no longer used. That is, the fourth type physical unit may not be put into the subsequent data access operation. In an exemplary embodiment, the fourth type physical unit is also referred to as a bad physical unit.

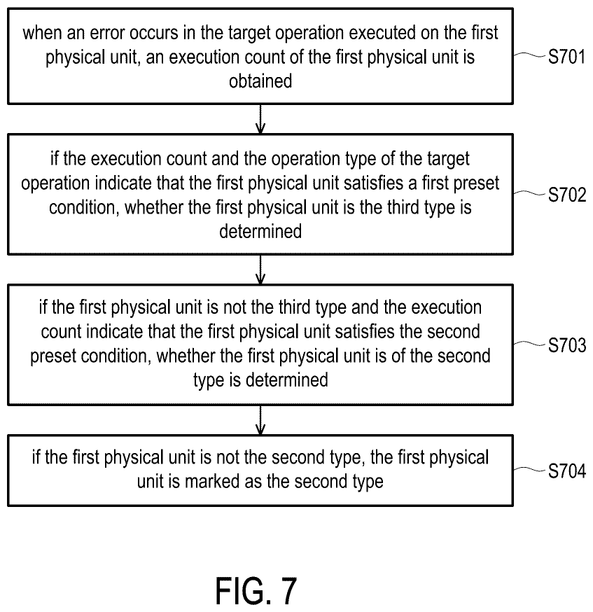

FIG. 7 is a flowchart of a memory control method according to an exemplary embodiment of the disclosure. Please refer to FIG. 7. When an error occurs in a target operation (for example, the erase operation, the write operation, or the read operation) executed on a first physical unit, the memory management circuit 51 may, for example, execute the memory control method as shown in FIG. 7 to extend the service life of the memory storage device 10.

In step S701, when an error occurs in the target operation executed on the first physical unit, an execution count of the first physical unit is obtained.

In an exemplary embodiment, the execution count may include but may not be limited to a read count and a PE count (program/erase count) of the first physical unit. Specifically, the memory management circuit 51 may obtain the execution count configured to characterize the actual usage condition of the first physical unit, and accordingly perform classification marking on the first physical unit.

In step S702, if the execution count and the operation type of the target operation indicate that the first physical unit satisfies a first preset condition, whether the first physical unit is the third type is determined.

In an exemplary embodiment, the operation type may be configured to characterize that the target operation is an erase operation, a write operation, or a read operation. Specifically, the execution count of the first physical unit and the operation type of the target operation may be configured to indicate whether the first physical unit satisfies the first preset condition. In an exemplary embodiment, the first preset condition includes that the target operation is not a read operation, or the target operation is a read operation and the read count of the first physical unit is not greater than a read threshold. If the target operation is not a read operation, or the target operation is a read operation and the read count of the first physical unit is not greater than the read threshold, the memory management circuit 51 may further determine whether the first physical unit is the third type (that is, a weak physical unit with poor condition).

The read threshold may be associated with the service life of the rewritable non-volatile memory module 43, or may be designed by the user according to actual requirements, which is not limited by the disclosure.

In step S703, if the first physical unit is not the third type and the execution count indicate that the first physical unit satisfies the second preset condition, whether the first physical unit is of the second type is determined.

Specifically, the execution count of the first physical unit may be configured to indicate whether the first physical unit satisfies the second preset condition. In an exemplary embodiment, the second preset condition includes that the erase count of the first physical unit is not greater than an erase threshold. If the first physical unit is not the third type (that is, the first physical unit is the first type or the second type with good condition) and the erase count of the first physical unit is not greater than the erase threshold, the memory management circuit 51 may further determine whether the first physical unit is the second type (that is, a physical unit to be inspected with good condition but having previously occurred errors).

The erase threshold may be associated with the service life of the rewritable non-volatile memory module 43, or may be designed by the user according to actual requirements, which is not limited by the disclosure.

In step S704, if the first physical unit is not the second type, the first physical unit is marked as the second type.

Specifically, if the first physical unit that is not the third type is also not the second type (that is, the first physical unit is the first type with good condition), the memory management circuit 51 may mark the first physical unit as the second type.

According to the above, as shown in the memory control method of FIG. 7, the memory management circuit 51 may execute a classification management mechanism according to the actual usage condition of the first physical unit, and may extend the service life of the memory storage device 10 under the premise of ensuring reliability of data.

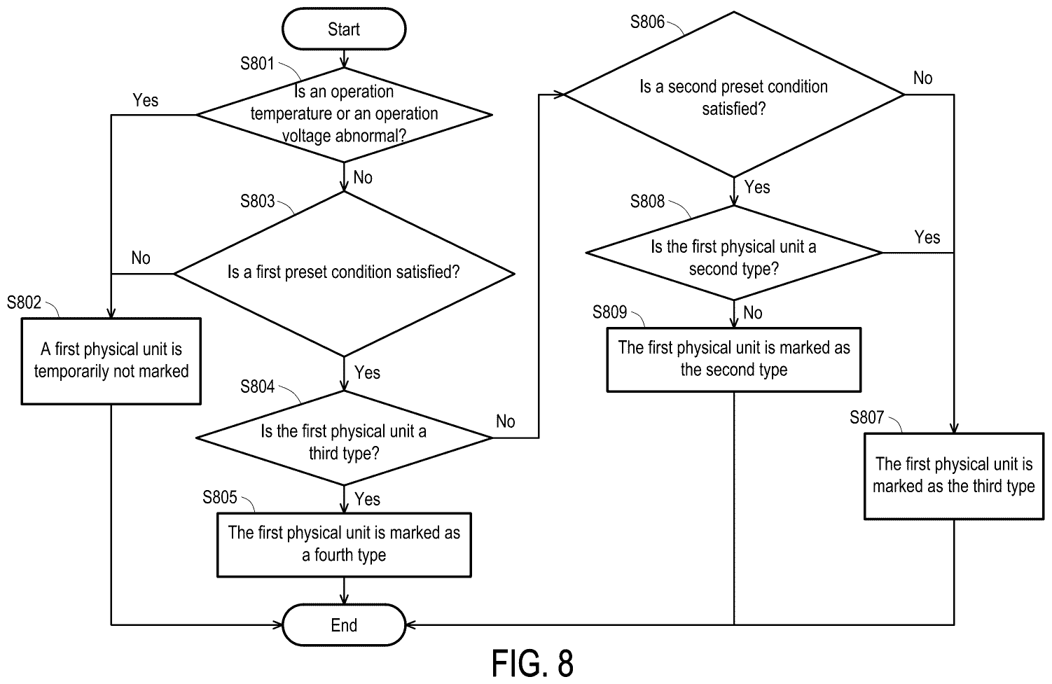

FIG. 8 is a flowchart of a memory control method according to an exemplary embodiment of the disclosure. Referring to FIG. 8, the memory control method shown in FIG. 8 is an extension of the memory control method shown in FIG. 7. When an error occurs in the target operation executed on the first physical unit, the memory management circuit 51 may, for example, execute the memory control method as shown in FIG. 8 to extend the service life of the memory storage device 10.

In step S801, the memory management circuit 51 may determine whether an operation temperature or an operation voltage corresponding to the target operation is abnormal.

Specifically, the memory management circuit 51 may determine whether the target operation with the error is interfered by the environmental factors by determining whether the operation temperature or the operation voltage corresponding to the target operation with the error is abnormal. If the operation temperature and/or the operation voltage is abnormal, then step S802 is proceeded. Conversely, if the operation temperature and the operation voltage are both normal, then step S803 is proceeded.

In step S802, the memory management circuit 51 may temporarily not mark the first physical unit.

In an exemplary embodiment, if the operation temperature and/or the operation voltage corresponding to the target operation is abnormal, it is shown that the memory management circuit 51 is interfered by the environmental factors when executing the target operation. Accordingly, when an error occurs in the target operation, the memory management circuit 51 may temporarily not mark the first physical unit corresponding to the operation (that is, the memory management circuit 51 temporarily does not change the type of the first physical unit), to avoid the problem that the storage space of the rewritable non-volatile memory module 43 is unnecessarily reduced due to mismarking the first physical unit that is not worn out.

In step S803, the memory management circuit 51 may determine whether the first physical unit satisfies the first preset condition.

In an exemplary embodiment, the memory management circuit 51 may obtain the execution count of the first physical unit executing the target operation. The execution count may include but may not be limited to the read count and erase count of the first physical unit.

The memory management circuit 51 may determine whether the first physical unit satisfies the first preset condition according to the execution count of the first physical unit and the operation type of the target operation, where the operation type may be configured to characterize that the target operation is the erase operation, the write operation, or the read operation. That is, the execution count of the first physical unit and the operation type of the target operation may be configured to indicate whether the first physical unit satisfies the first preset condition.

In an exemplary embodiment, the first preset condition includes that the target operation is not a read operation, or the target operation is a read operation and the read count of the first physical unit is not greater than a read threshold.

The read threshold may be associated with the service life of the rewritable non-volatile memory module 43, or designed by the user according to actual requirements, which is not limited by the disclosure.

If the execution count of the first physical unit and the operation type of the target operation indicate that the first physical unit does not satisfy the first preset condition (that is, the target operation is the read operation and the read count is greater than the read threshold), then step S802 is proceeded. The memory management circuit 51 may temporarily not mark the first physical unit.

Specifically, the first physical unit having the high read count (that is, the read count is greater than the read threshold) may only characterize that the first physical unit is used with high frequency, and does not characterize that the first physical unit is a damaged physical unit. Therefore, the memory management circuit 51 may temporarily not change the type of the first physical unit, to avoid the problem that the storage space of the rewritable non-volatile memory module 43 is unnecessarily reduced due to mismarking.

Conversely, if the execution count of the first physical unit and the operation type of the target operation indicate that the first physical unit satisfies the first preset condition, then step S804 is proceeded. The memory management circuit 51 may determine whether the first physical unit is the third type.

In an exemplary embodiment, the memory management circuit 51 may further determine whether the first physical unit satisfying the first preset condition is a weak physical unit with poor condition.

If the first physical unit is the third type, then step S805 is proceeded. The memory management circuit 51 may mark the first physical unit as the fourth type.

Specifically, when the first physical unit with poor condition (that is, the first third type physical unit) has an error, the memory management circuit 51 may determine that the first physical unit is a damaged physical unit. Accordingly, the memory management circuit 51 may mark the first physical unit as the fourth type. That is, the memory management circuit 51 may mark the first physical unit as a bad physical unit, so that the first physical unit is no longer used in the subsequent data access operation, to maintain reliability of data.

Conversely, if the first physical unit is not the third type (that is, the first physical unit is the first type or the second type with good condition), then step S806 is proceeded. The memory management circuit 51 may further determine whether the first physical unit satisfies the second preset condition.

In an exemplary embodiment, the second preset condition includes that the erase count of the first physical unit is not greater than an erase threshold. That is, the execution count of the first physical unit may be configured to indicate whether the first physical unit satisfies the second preset condition.

The erase threshold may be associated with the service life of the rewritable non-volatile memory module 43, or may be designed by the user according to actual requirements, which is not limited by the disclosure.

If the execution count of the first physical unit indicates that the first physical unit does not satisfy the second preset condition (that is, the erase count of the first physical unit is greater than the erase threshold), then step S807 is proceeded. The memory management circuit 51 may mark the first physical unit as the third type.

Specifically, the first physical unit having the high erase count (that is, the erase count is greater than the erase threshold) indicates that the first physical unit has been used in many times. Therefore, when an error occurs in the operation corresponding to the first physical unit that has been used in many times, the memory management circuit 51 may mark the first physical unit as the third type with poor condition.

Conversely, if the execution count of the first physical unit indicates that the first physical unit satisfies the second preset condition, then step S808 is proceeded. The memory management circuit 51 may further determine whether the first physical unit is the second type.

If the first physical unit is not the second type, then step S809 is proceeded.

Conversely, if the first physical unit is of the second type, then step S807 is proceeded.

Specifically, the first physical unit having the low erase count (that is, the erase count is not greater than the erase threshold) indicates that the first physical unit has not been used in many times. Therefore, when an error occurs in the operation corresponding to the first physical unit that has not been used in many times, the memory management circuit 51 may further determine whether the first physical unit is the first type or the second type, and accordingly execute corresponding marking on the first physical unit.

If the first physical unit is of the second type with good condition but having previously occurred errors, then in step S807, the memory management circuit 51 may mark the first physical unit as the third type.

Conversely, if the first physical unit is of the first type with good condition and having not previously occurred errors, then in step S809, the memory management circuit 51 may mark the first physical unit as the second type.

It is worth mentioning that the second type physical unit is a physical unit to be inspected. In the idle state, the memory management circuit 51 may execute the target test operation on the second type physical unit to determine whether the physical unit may be used for the subsequent data access operation, which may improve reliability of data.

According to the above, as shown in the memory control method of FIG. 8, when subjected to the influence of the environmental factors (that is, abnormal operating temperature and/or abnormal operating voltage) or facing the first physical unit has the high read count, the memory management circuit 51 may temporarily not mark the first physical unit corresponding to the target operation in which an error occurs as the bad physical unit, to avoid the problem that the storage space is unnecessarily reduced due to mismarking, and execute a classification management mechanism according to the actual usage condition of the first physical unit, which may extend the service life of the memory storage device 10 under the premise of ensuring reliability of data.

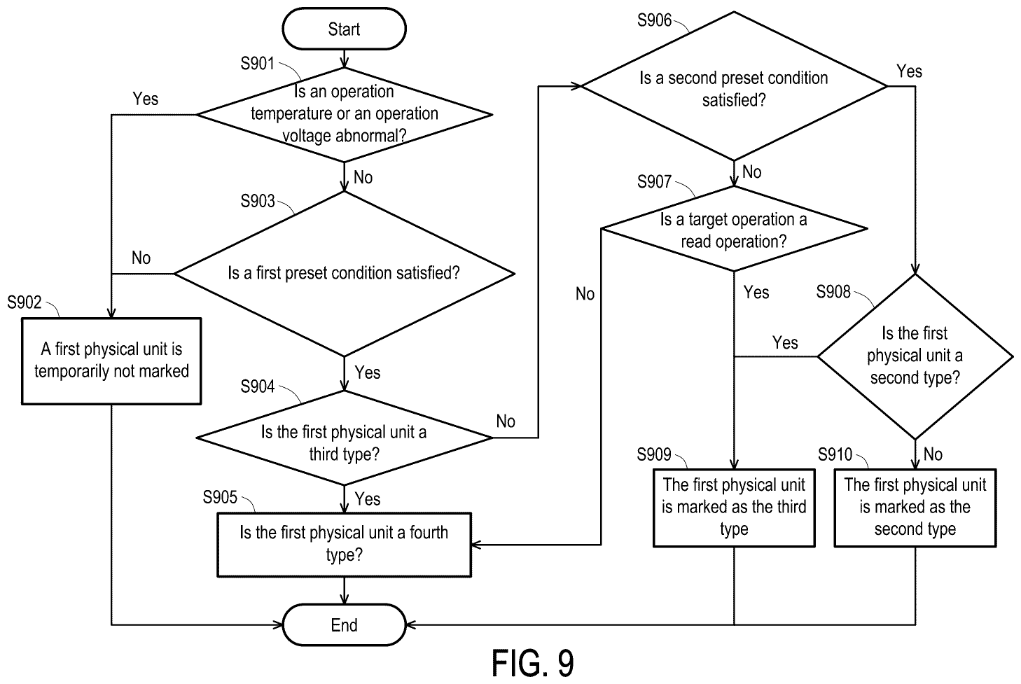

FIG. 9 is a flowchart of a memory control method according to an exemplary embodiment of the disclosure. Referring to FIG. 9, the memory control method shown in FIG. 9 is an extension of the memory control method shown in FIG. 7. When an error occurs in the target operation executed on the first physical unit, the memory management circuit 51 may be configured to execute the memory control method as shown in FIG. 9 to extend the service life of the memory storage device 10.

In step S901, the memory management circuit 51 may determine whether the operating temperature or operating voltage corresponding to the target operation is abnormal to determine whether the target operation in which an error occurs is interfered by the environmental factors.

If the operating temperature and/or operating voltage is abnormal (that is, the target operation in which an error occurs is interfered by the environmental factors), then step S902 is proceeded. The memory management circuit 51 may temporarily not mark the first physical unit to avoid the problem that the storage space of the rewritable non-volatile memory module 43 is unnecessarily reduced due to mismarking.

Conversely, if the operating temperature and operating voltage are both normal (that is, the target operation in which an error occurs is not interfered by the environmental factors), then step S903 is proceeded.

In step S903, the memory management circuit 51 may determine whether the first physical unit satisfies the first preset condition.

In an exemplary embodiment, the memory management circuit 51 may obtain the execution count of the first physical unit. For example, the execution count may include but may not be limited to the read count and erase count of the first physical unit. The memory management circuit 51 may determine whether the first physical unit satisfies the first preset condition according to the execution count of the first physical unit and the operation type of the target operation, where the operation type may be configured to characterize that the target operation is the erase operation, the write operation, or the read operation.

In an exemplary embodiment, if the target operation is the read operation and the read count of the first physical unit is greater than the read threshold, the memory management circuit 51 may determine that the first physical unit does not satisfy the first preset condition, and step S902 is proceeded. The memory management circuit 51 may temporarily not mark the first physical unit to avoid the problem that storage space is unnecessarily reduced due to mismarking. Conversely, if the target operation is not the read operation, or the target operation is the read operation and the read count of the first physical unit is not greater than the read threshold, the memory management circuit 51 may determine that the first physical unit satisfies the first preset condition, and step S904 is proceeded. The memory management circuit 51 may determine whether the first physical unit is the third type.

If the first physical unit is the third type with poor condition, then step S905 is proceeded. The memory management circuit 51 may mark the first physical unit as the fourth type, so that the first physical unit is no longer be used in the subsequent data access operation to maintain reliability of data.

Conversely, if the first physical unit is not the third type (that is, the first physical unit is of the first type or second type with good condition), then step S906 is proceeded. The memory management circuit 51 may further determine whether the first physical unit satisfies the second preset condition.

If the erase count of the first physical unit is greater than the erase threshold, the memory management circuit 51 may determine that the first physical unit does not satisfy the second preset condition, and step S907 is proceeded. The memory management circuit 51 may determine whether the target operation is the read operation.

If the target operation is the read operation, then step S909 is proceeded. Conversely, if the target operation is not the read operation, then step S905 is proceeded.

Specifically, the first physical unit has the high erase count (that is, the erase count is greater than the erase threshold), which indicates that the first physical unit has been used in many times. If the target operation in which an error occurs is a read operation, and the first physical unit has been used in many times, then in step S909, the memory management circuit 51 may mark the first physical unit as the third type.

The memory management circuit 51 may mark the first physical unit as the third type rather than marking the first physical unit that has been used in many times and corresponds to the target operation in which an error occurs as the fourth type (that is, the bad physical unit), to attempt to extend the service life of the memory storage device 10.

Conversely, if the target operation in which an error occurs is an erase operation or a write operation, and the first physical unit has been used in many times, then in step S905, the memory management circuit 51 may mark the first physical unit as the fourth type, so that the first physical unit is no longer be used in the subsequent data access operation to maintain reliability of data.

In another aspect, if the erase count of the first physical unit is not greater than the erase threshold, the memory management circuit 51 may determine that the first physical unit satisfies the second preset condition, and step S908 is proceeded. The memory management circuit 51 may further determine whether the first physical unit is the second type.

If the first physical unit is of the second type, then step S909 is proceeded. Conversely, if the first physical unit is not the second type, then step S910 is proceeded.

Specifically, the first physical unit has the low erase count (that is, the erase count is not greater than the erase threshold), which indicates that the first physical unit has not been used in many times.

If the first physical unit is of the second type with good condition but having previously occurred errors, then in step S909, the memory management circuit 51 may mark the first physical unit as the third type.

Conversely, if the first physical unit is of the first type with good condition and having no previously occurred errors, then in step S909, the memory management circuit 51 may mark the first physical unit as the second type.

According to the above, as shown in the memory control method of FIG. 9, when subjected to the influence of the environmental factors (that is, abnormal operating temperature and/or abnormal operating voltage) or facing the first physical unit has the high read count, the memory management circuit 51 may temporarily not mark the first physical unit corresponding to the target operation in which an error occurs as the bad physical unit, to avoid the problem that storage space is unnecessarily reduced due to mismarking, and execute the classification management mechanism according to the actual usage condition of the first physical unit, which may extend the service life of the memory storage device 10 under the premise of ensuring reliability of data.

It should be noted that in addition to the memory control methods as shown in FIG. 7 to FIG. 9, if the target operation in which an error occurs is an erase operation or a write operation, the memory management circuit 51 may also select the second physical unit different from the first physical unit from the rewritable non-volatile memory module 43 to re-execute the erase operation in which an error occurs or the write operation in which an error occurs, so that the operation of the memory storage device 10 may not be interrupted.

In addition to the memory control methods as shown in FIG. 7 to FIG. 9, if the target operation in which an error occurs is a read operation and the first physical unit has not been marked as the fourth type, the memory management circuit 51 may also further confirm whether the read operation corresponding to the first physical unit occurs an error again under the condition that the environmental factors are normal and the read count does not exceed the read threshold after a data consolidation operation (for example, a garbage collection operation). If so, the memory management circuit 51 may mark the first the second type physical unit (or the third type) as the third type (or the fourth type) to ensure reliability of data. If not, the memory management circuit 51 may mark the first physical unit as the first type to improve the service life of the memory storage device 10.

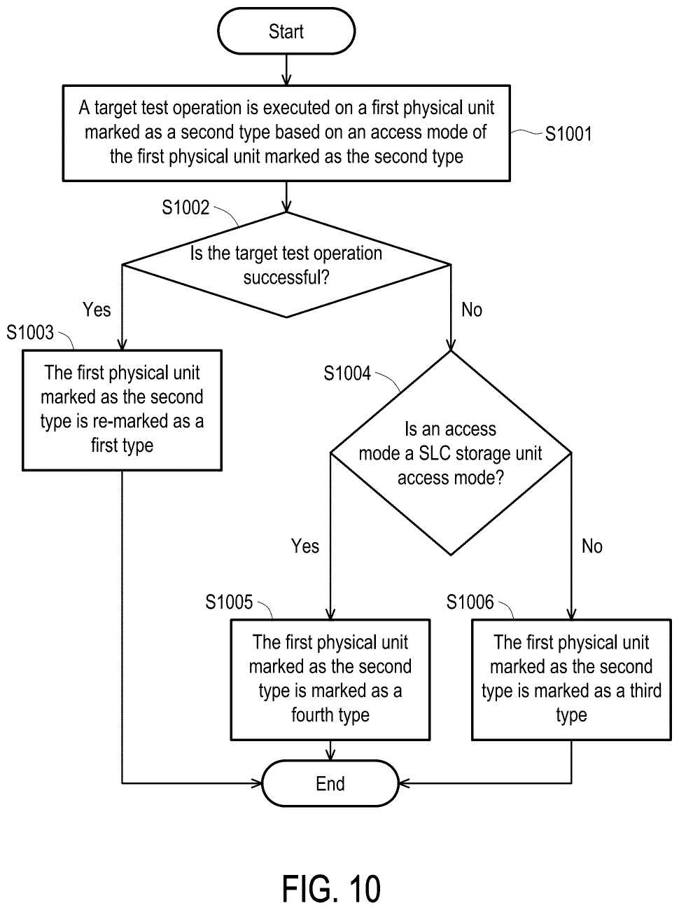

FIG. 10 is a flowchart of a memory control method for a physical unit to be inspected according to an exemplary embodiment of the disclosure. Referring to FIG. 10, it is worth mentioning that the memory control method for the physical unit to be inspected shown in FIG. 10 is executed in an idle state and/or a background state.

In step S1001, the memory management circuit 51 may execute a target test operation on the first physical unit marked as the second type based on the access mode of the first physical unit marked as the second type.

In an exemplary embodiment, the target test operation may include but may not be limited to an erase operation, a write operation, and a read verify operation. For example, the access mode of the first physical unit marked as the second type (that is, the physical unit to be inspected) is the TLC storage unit access mode. The memory management circuit 51 may first execute the erase operation on the first physical unit marked as the second type, then write test data into the first physical unit marked as the second type based on the TLC storage unit access mode, and then execute the read verify operation on the first physical unit marked as the second type based on the TLC storage unit access mode to determine whether the test data is correctly written.

In step S1002, the memory management circuit 51 may determine whether the target test operation successes.

In an exemplary embodiment, if the read verify operation is successful, it is shown that the test data is correctly written into the first physical unit marked as the second type. Accordingly, the memory management circuit 51 may determine that the target test operation successes.

Conversely, if the read verify operation fails, it is shown that the test data is not correctly written into the first physical unit marked as the second type. Accordingly, the memory management circuit 51 may determine that the target test operation fails.

If the target test operation is successful, then step S1003 is proceeded. Conversely, if the target test operation fails, then step S1004 is proceeded.

In step S1003, the memory management circuit 51 may re-mark the first physical unit marked as the second type as the first type.

Specifically, if the target test operation for the first physical unit marked as the second type is successful, it is shown that the error that previously occurred in the operation corresponding to the first physical unit marked as the second type is a temporary error. Accordingly, the memory management circuit 51 may re-mark the first physical unit marked as the second type as the first type with good condition (that is, a good physical unit), so as to improve the service life of the first physical unit, and extend the service life of the memory storage device 10 under the premise of ensuring reliability of data.

In another aspect, in step S1004, the memory management circuit 51 may further determine whether the access mode of the first physical unit marked as the second type is the SLC storage unit access mode.

If the determination is yes, then step S1005 is proceeded. The memory management circuit 51 may mark the first physical unit marked as the second type as the fourth type. In an exemplary embodiment, the third type physical unit may only be used for the SLC

storage unit access mode. Therefore, if the target test operation of the first physical unit marked as the second type fails and the access mode is the SLC storage unit access mode, that is, at least under the SLC storage unit access mode, the first physical unit marked as the second type may not be correctly accessed, the memory management circuit 51 may mark the first physical unit as the fourth type (that is, a bad physical unit), so that the first physical unit is no longer put into the subsequent data access operation to avoid problems of data loss and/or data corruption.

Conversely, if the determination is no, then step S1006 is proceeded. The memory management circuit 51 may mark the first physical unit marked as the second type as the third type.

Specifically, if the target test operation of the first physical unit marked as the second type fails and the access mode is not the SLC storage unit access mode (for example, the TLC storage unit access mode), that is, perhaps under the SLC storage unit access mode, the first physical unit marked as the second type may be correctly accessed, the memory management circuit 51 may mark the first physical unit as the third type (that is, a weak physical unit), so as to use the first physical unit to store data with lower importance.

According to the above, as shown in the memory control method of FIG. 10, the target test operation may be executed on the physical unit to be inspected (that is, the second type physical unit) in the idle state, the physical unit to be inspected with the successful target test operation may be restored to the good physical unit, and the physical unit to be inspected with the failed target test operation may be marked as the weak physical unit or the bad physical unit. By further executing a classification management mechanism on the physical unit to be inspected, it may be achieved that, according to the actual operating conditions of the storage device, a physical unit management mechanism is established to perform classification marking on the physical units with different usage conditions, thereby reducing misjudgment of physical unit classification and extending the service life of the memory storage device 10 under the premise of ensuring reliability of data.

In summary, the memory control method and memory storage device proposed by the exemplary embodiments of the disclosure may temporarily not execute marking when the environmental factors are abnormal to avoid mismarking, and execute the classification management mechanism according to the actual usage conditions of the physical unit corresponding to the target operation in which an error occurs, and execute the target test operation on the physical unit to be inspected in the idle state to execute further classification management mechanism for the physical unit to be inspected, which may effectively extend the service life of the memory storage device under the premise of ensuring reliability of data.

Finally, it should be noted that the aforementioned embodiments are only configured to illustrate the technical solutions of the disclosure, rather than to limit thereto. Although the disclosure has been described in detail with reference to the aforementioned embodiments, persons skilled in the art should understand that the technical solutions described in the aforementioned embodiments may still be modified, or equivalent substitutions may be performed for some or all of the technical features therein. These modifications or substitutions do not cause the essence of the corresponding technical solutions to depart from the scope of the technical solutions of the embodiments of the disclosure.

What is claimed is:

1. A memory control method, used for a rewritable non-volatile memory module, wherein the rewritable non-volatile memory module comprises a plurality of physical units, and the plurality of physical units are respectively marked as the first, second, third, or fourth type, the memory control method comprising:
when an error occurs in a target operation executed on a first physical unit, obtaining an execution count of the first physical unit;
if the execution count and operation type indicate that the first physical unit satisfies the first preset condition, determining whether the first physical unit is the third type;
if the first physical unit is not the third type and the execution count indicates that the first physical unit satisfies the second preset condition, determining whether the first physical unit is the second type; and
if the first physical unit is not the second type, marking the first physical unit as the second type.

2. The memory control method according to claim 1, wherein the first preset condition comprises:
the target operation is not a read operation, or the target operation is the read operation and the execution count does not exceed a read threshold, wherein the execution count is a read count; and
wherein the second preset condition comprises:
the execution count does not exceed an erase threshold, wherein the execution count is an erase count.

3. The memory control method according to claim 1, wherein before the step of obtaining the execution count of the first physical unit, the memory control method further comprises:
determining whether an operation temperature or an operation voltage corresponding to the target operation is abnormal; and
if at least one of the operation temperature and the operation voltage is abnormal, temporarily not marking the first physical unit.

4. The memory control method according to claim 1, further comprising:
if the execution count and the operation type of the target operation indicate that the first physical unit does not satisfy the first preset condition, temporarily not marking the first physical unit.

5. The memory control method according to claim 1, further comprising:
if the first physical unit is the third type, marking the first physical unit as the fourth type;
if the first physical unit is not the third type and the execution count indicates that the first physical unit does not satisfy the second preset condition, marking the first physical unit as the third type.

6. The memory control method according to claim 5, wherein the step of marking the first physical unit as the third type comprises:
determining whether the target operation is a read operation;
if yes, marking the first physical unit as the third type;
if no, marking the first physical unit as the fourth type.

7. The memory control method according to claim 1, further comprising:
if the first physical unit is the second type, marking the first physical unit as the third type.

8. The memory control method according to claim 1, further comprising:
in an idle state, based on an access mode of the first physical unit marked as the second type, executing a target test operation on the first physical unit marked as the second type; and
if the target test operation successes, re-marking the first physical unit marked as the second type as the first type.

9. The memory control method according to claim 8, further comprising:
if the target test operation fails and the access mode is a single level cell storage unit access mode, marking the first physical unit marked as the second type as the fourth type; and
if the target test operation fails and the access mode is not a single level cell storage unit access mode, marking the first physical unit marked as the second type as the third type.

10. The memory control method according to claim 1, wherein the plurality of physical units are all the first type at an initial stage; and
wherein the first physical unit marked as the third type is only used for a single level cell storage unit access mode.

11. A memory storage device, comprising:
a connection interface unit, coupled to a host system;
a rewritable non-volatile memory module, wherein the rewritable non-volatile memory module comprises a plurality of physical units, and the plurality of physical units are respectively marked as the first, second, third, or fourth type; and
a memory control circuit unit, coupled to the connection interface unit and the rewritable non-volatile memory module,
wherein the memory control circuit unit is configured to:
when an error occurs in a target operation executed on a first physical unit, obtain an execution count of the first physical unit;
if the execution count and operation type indicate that the first physical unit satisfies the first preset condition, determine whether the first physical unit is the third type;
if the first physical unit is not the third type and the execution count indicates that the first physical unit satisfies the second preset condition, determine whether the first physical unit is the second type; and
if the first physical unit is not the second type, marking the first physical unit as the second type.

12. The memory storage device according to claim 11, wherein the first preset condition comprises:
the target operation is not a read operation, or the target operation is the read operation and the execution count is not greater than a read threshold, wherein the execution count is a read count; and
wherein the second preset condition comprises:
the execution count is not greater than an erase threshold, wherein the execution count is an erase count.

13. The memory storage device according to claim 11, wherein before the memory control circuit unit obtains the execution count of the first physical unit, the memory control circuit unit is further configured to determine whether an operation temperature or an operation voltage corresponding to the target operation is abnormal, and
if at least one of the operation temperature and the operation voltage is abnormal, the memory control circuit unit is further configured to temporarily not mark the first physical unit.

14. The memory storage device according to claim 11, wherein if the execution count and the operation type of the target operation indicate that the first physical unit does not satisfy the first preset condition, the memory control circuit unit is further configured to temporarily not mark the first physical unit.

15. The memory storage device according to claim 11, wherein if the first physical unit is the third type, the memory control circuit unit is further configured to mark the first physical unit as the fourth type;
wherein if the first physical unit is not the third type and the execution count indicates that the first physical unit does not satisfy the second preset condition, the memory control circuit unit is further configured to mark the first physical unit as the third type.

16. The memory storage device according to claim 15, wherein the memory control circuit unit is further configured to determine whether the target operation is a read operation, and
if the target operation is a read operation, the memory control circuit unit is further configured to mark the first physical unit as the third type;
wherein if the target operation is not a read operation, the memory control circuit unit is further configured to mark the first physical unit as the fourth type.

17. The memory storage device according to claim 11, wherein if the first physical unit is the second type, the memory control circuit unit is further configured to mark the first physical unit as the third type.

18. The memory storage device according to claim 11, wherein in an idle state, the memory control circuit unit is further configured to execute a target test operation on the first physical unit marked as the second type based on an access mode of the first physical unit marked as the second type, and
if the target test operation successes, the memory control circuit unit is further configured to re-mark the first physical unit marked as the second type as the first type.

19. The memory storage device according to claim 11, wherein if the target test operation fails and an access mode is a single level cell storage unit access mode, the memory control circuit unit is further configured to mark the first physical unit marked as the second type as the fourth type; and
wherein if the target test operation fails and the access mode is not a single level cell storage unit access mode, the memory control circuit unit is further configured to mark the first physical unit marked as the second type as the third type.

20. The memory storage device according to claim 11, wherein the plurality of physical units are all the first type at an initial stage; and
wherein the first physical unit marked as the third type is only used for a single level cell storage unit access mode.
